(19) United States
(12) Patent Application Publication
(10) Pub. No.: US 2011/0320560 A1
(43) Pub. Date: Dec. 29, 2011

(54) CONTENT AUTHORING AND PROPAGATION AT VARIOUS FIDELITIES

(75) Inventors: Eric Paul Bennett, Bellevue, WA (US); Christian James Colando, Seattle, WA (US); Matthew Bret MacLaurin, Woodinville, WA (US); Scott V. Fynn, Seattle, WA (US); Blaise H. Aguera y Arcas, Seattle, WA (US); Eric S. Anderson, Seattle, WA (US); Steven C. Glenner, Bellevue, WA (US)

(73) Assignee: MICROSOFT CORPORATION, Redmond, WA (US)

(21) Appl. No.: 12/826,657

(22) Filed: Jun. 29, 2010

(51) Int. Cl. G06F 15/16

(52) U.S. Cl. 709/217

(57) ABSTRACT

Content may be authored on a device using various types of information, and may be propagated at various different fidelities. In one example, a user enters or captures information on a mobile device, such as a smart phone. The entered and/or captured information may be sent to a remote service, which provides information based on the entered and/or captured data. An application on the device then allows the user of the device to author rich content based on the entered and/or captured data, and based on the information returned from the service. The application may allow the user to include text, photos, video, audio, links, or any other type of content. The entire content object that the user creates may be stored in a structured form, and may be propagated at various different fidelities (e.g., text only, etc.) in order to accommodate the limitations of the propagation channel.

### BACKGROUND

One social behavior that has developed around the use of computers and computer-like devices is that people now tend to share information about themselves in real time. Social networking services such as Facebook, and microblogging services such as Twitter, allow users to give real-time status reports on where they are, what they are doing, what they are thinking about, etc. These status reports normally take the form of text, possibly accompanied by a photo or a link to other content. The content is normally entered by a person, and posted on the site. For example, a person might use a desktop computer or mobile device to type a short update on his status. He might capture a photo with a camera on the device, or might link to a web page that he has navigated to with a browser on the device.

In the recent past, computer-based communication was limited to sending text-only e-mails from wired desktop computers. Being able to send text, a photo, and a link from untethered mobile devices certainly represents advancement over the prior state of technology. However, even the ability to send text and photos from phones makes relatively little use of the available technology. Since computers and phones have the ability to connect to a wide range of “cloud” services that can process all types of input, the process of creating and communicating content can be made richer than merely a user's typing a message and taking a photo.

### SUMMARY

The process of creating and sending content can be based on various types of input at the sending device, and can make use of various types of remote services. In this way, a user can develop content from a many different kinds of input available at the device, and can propagate the content in several different fidelities. Text and images are two types of input that may be provided. However, other types of input may be captured such as location input from a Global Positioning System (GPS), audio input, the current temperature, motion data, etc. This input may be augmented by various types of “cloud” services. For example, an image could be sent to a cloud service. The cloud service could identify the image by comparing the image with an image database, in order to identify what is shown in the image (e.g., a comparison might reveal that the image is of a famous landmark building, and the name of the building could be returned to the user). The service could then provide information related to what is shown in the image.

Once the information received from the cloud service is provided, a user may build content around that information, so that the content can be propagated to others. For example, if a user captures an image of the Seattle Space Needle on his phone, the image can be sent to a cloud service to identify the image as being that of Space Needle. Additionally, the cloud service can provide links to attractions near Space Needle (e.g., the Pacific Science Center). Based on the photo that was captured and the information that is returned from the cloud, an application can assist the user in authoring content that can be propagated as social media. A content authoring interface might allow the user to create content that includes the photo, as well as other information downloaded from the cloud. The user may be given the opportunity to choose which information is to be included in the content. Once the content is created, the user can propagate the content through a variety of channels—e.g., a social network, a microblog, e-mail, a text message, etc.

It may be possible to experience the same piece of content in various fidelities, depending on the medium through which the content is propagated and the device on which the content is to be viewed. The highest fidelity contains all of the information that the user included in the content that he authored—e.g., text, photos, video, audio, links, etc. Sufficient information can be stored about what is available on the user's device to enable another user to recreate that experience—i.e., to see the text, photos, video, audio, links, etc. However, not all channels can reproduce the experience at the highest fidelity. Based on the particular channel through which the user propagates the content, the content might be experienced at lower fidelities. For example, if the user posts the content on Twitter, then the post might contain only the text message, plus a link to the higher fidelity experience. If the user posts the content on Facebook, then the post might contain the picture of Space Needle and the text, with a link to a richer experience. The particular fidelity at which the user experiences the content may depend on the way in which the user propagates the content and the device on which the content is being viewed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example user interface in which a content object may be constructed.

FIG. 2 is a block diagram of an example scenario in which content may be authored and propagated.

FIG. 3 is a block diagram of an example scenario in which a given piece of content may be managed at various fidelities.

FIG. 4 is a block diagram of an example process in which content may be authored.

FIG. 5 is a block diagram of example components that may be used in connection with implementations of the subject matter described herein.

### DETAILED DESCRIPTION

One type of social behavior that has developed around computers, and around devices such as smart phones, is that people like to share information about themselves in real time. Many people participate in services such as social networks, microblogs, etc., and post their status. Additionally, many people send informal text messages to each other describing what they are doing. For example, if a person is at a museum, it would not be uncommon for that person to post a statement such as “like the natural history exhibit” on Twitter or Facebook. Some services allow users to add a link or a photo to their post. However, these types of status updates are generally limited to content that the user specifically enters or captures. The underlying devices could support a richer and more varied content experience.

Since computers and phones are connected to networks, it is possible to supplement content that the user enters or captures with content received from a remote source. Moreover, computers and phones often have sensors that provide data, and the data from these sensors can be used to create content. For example, many phones have the ability to determine their location either through a Global Position System (GPS) receiver or through triangulation. Some phones may have thermometers that can determine the ambient temperature. Information such as location, temperature, etc., which is captured passively, can be used to augment the creation of content. This type of data either could be included in the content to be posted, or could be provided to a remote service, which can use the information to provide relevant information to the device. The information returned by the service can then be included in the content that is being authored. For example, if a user captures an image of a famous landmark (e.g., Seattle's Space Needle), that image—combined with the latitude and longitude of the device, as reported by a GPS receiver—could be sent to a remote service, and the remote service could use both the photo and the GPS location to help identify the landmark in the photo. Links, photos, videos, audio clips, blog posts, social network status, or any other type of information relating to the landmark could then be returned to the device. An application on the device could then help the user to author content relating to the original photo, where the authored content may contain information received from the remote service. The resulting content then may include text, video, audio, images, links, blog posts, or any other type of content. This content can then be propagated as social media, by posting the content to a social network, a blog, or a microblog, or by sending the content in an e-mail.

The various different channels through which the content may be propagated may support different levels of fidelity. Fidelity, in this context, refers to the capabilities of the channel through which the content will be transmitted, and/or the device on which content will be displayed. For example, Twitter supports 140-character text messages, which may include links. Thus, if a piece of content to be posted contains text, images, video, and audio and a user wants to post the content on Twitter, the content might be posted at a relatively low fidelity—e.g., just the text, together with a link to the rest of the content. If the content is to be posted on Facebook, then the post might contain text and still images, with a link to the rest of the content. The full content that is created may be stored in a server, possibly in a structured form, thereby allowing recreation of as much or as little of the content experience as is appropriate for the circumstances. If someone receives the post through Twitter, that person might be intrigued by the text in the post. He or she could then click the link, which would then allow the person to experience the full content—e.g., image, video, audio, etc.—through a browser. Or, if a user has posted content on Twitter and wants to repost the same content on Facebook, the Facebook version of the content could be reconstructed in a fidelity that is appropriate for Facebook's capabilities.

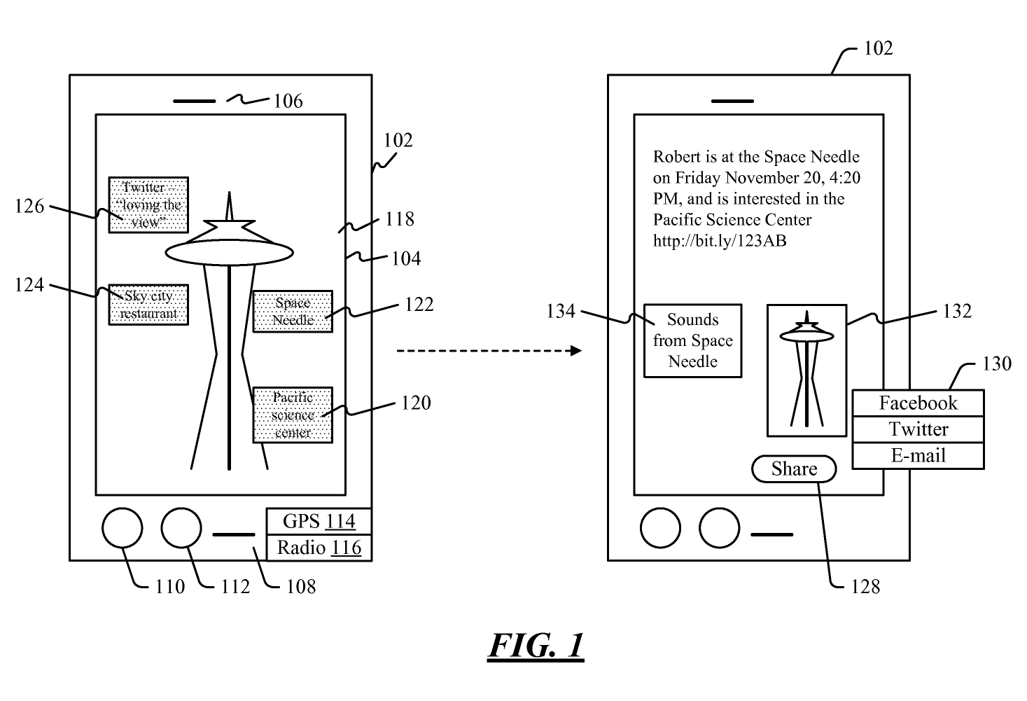

Turning now to the drawings, FIG. 1 shows an example user interface in which a content object may be constructed. In the example of FIG. 1, the device 102 on which the interface is shown is depicted as a smart phone, although the techniques described herein could be used to create content on any type of device with some computing capability. A phone, a handheld computer, a desktop computer, a laptop computer, a tablet, a music player, and a camera are some examples of devices on which the techniques described herein could be performed.

Device 102 may contain various components such as touch screen 104, speaker 106, microphone 108, camera 110, button 112, GPS receiver 114, and radio 116. Speaker 106 and microphone 108 may provide audio output and input, respectively, for device 102. Camera 110 may provide visual input for device 102. Button 112 may provide a mode of allowing a user to interact with software on device 102—e.g., device 102 may be configured to provide a menu of software or other options when a user presses button 112. GPS receiver 114 may receive signals from satellites, and may contain logic to determine the location of device 102 based on those signals. Radio 116 may allow device 102 to engage in two-way communication through electro-magnetic waves (e.g., by allowing device 102 to communicate with cellular communication towers). Touch screen 104 may act as both a visual output device and a tactile input device.

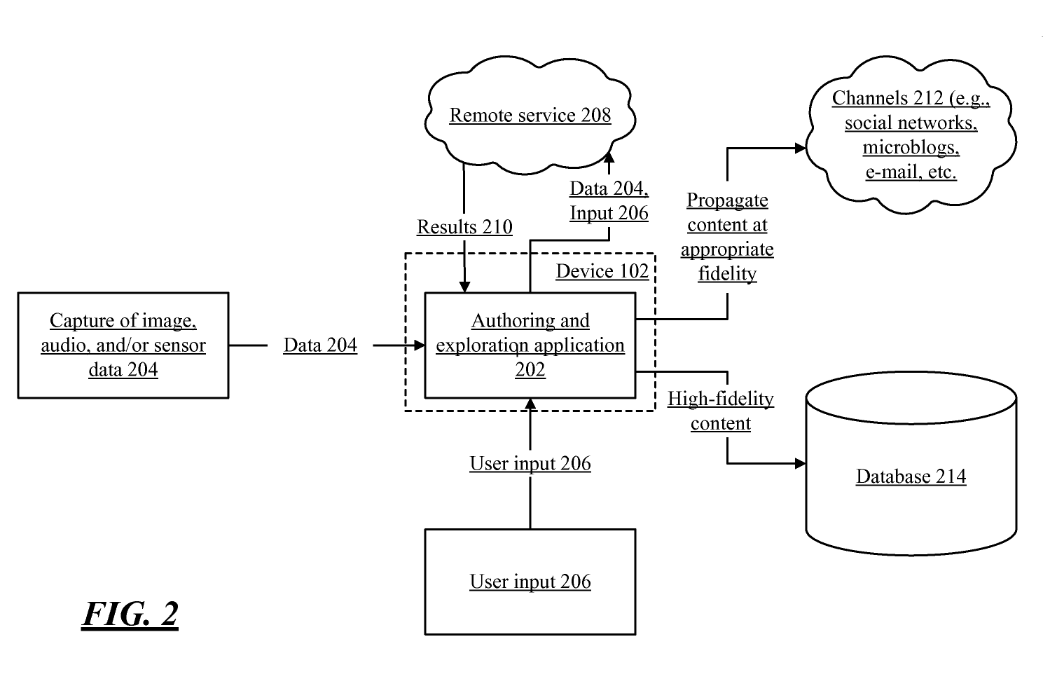

In the example of FIG. 1, a user has used camera 110 to take a photo of a famous landmark (Seattle's Space Needle). Software that operates on device 102 provides user interface 118, which shows the photo that has been taken with camera 110. Additionally, user interface 118 includes various elements 120, 122, 124, and 126, which refer to objects associated with Space Needle. These elements allow the user to access various content items, or to perform various actions. In particular, element 120 refers to the Pacific Science Center, which is an attraction located near Space Needle. Element 122 may contain a link to the web site for Space Needle itself. Element 124 refers to a restaurant in the Space Needle building. Element 126 refers to a Twitter post concerning Space Needle. These elements may be displayed based on information that device 102 receives from a remote service (which may be referred to as a “cloud” service). For the purpose of FIG. 1, it will be assumed that device 102 obtained the information that is referenced by elements 120-126 from a cloud service in some manner. We will defer to FIG. 2 a discussion of the details of how that information is obtained, and what the cloud service does. However, very generally, there may be an application on device 102 that, upon a user's taking a photo, sends the photo to the cloud service in order to find out relevant information about what is shown in the photo. The cloud service may be able to identify the object in the photo based on visual comparison with a database of photos, and may then return information that is relevant to the identified object. That information may come from web sites, Twitter posts, blogs, or any other source that is available on the web. Once these sources of information are identified by the cloud service, they are represented in the form of elements in user interface 118. Clicking on one of these elements allows a user to access the underlying content, and to create a piece of social media based on that content. This piece of social media can then be propagated.

The view of device 102 on the right-hand side of FIG. 1 shows what happens if the user clicks on element 120 (or touches that element using the touch screen). Element 120 refers to the Pacific Science Center. The cloud service may have returned, for example, a link to the Pacific Science Center's web site. When the user clicks on the Pacific Science Center element (element 120), this click may indicate to an application on device 102 that the user is interested in the Pacific Science Center. Thus, the application may generate content based on the original photo and based on the user's interest in the Pacific Science Center. In the example shown, this content includes a text message stating that the user is at Space Needle and that he is interested in the Pacific Science Center. The message also contains the current time, and a link to the Pacific Science Center's web site (in a shorted form, using a URL-shortening service such as bit.ly). The message may also contain any other type of media experience. For example, the message may contain the photo 132 of Space Needle that the user took on the device's camera, or may contain audio 134 that was captured by the device during the user's visit to Space Needle.

The user may have the opportunity to edit the content item. For example, the user may choose to edit the text, to add or remove links, to add or remove photos, or perform any other action. Appropriate user controls may be provided to allow for this editing, such as a set of menus that allows the user to change nouns or verbs in the text.

When the user edits the content item, the user may share the content item by clicking the share button 128. Clicking that button may cause a menu 130 to be presented, which allows the user to share the content item through various channels, such as a social networking site (e.g., Facebook), a microblogging site (e.g., Twitter), e-mail, or any other type of channel.

As noted above, the particular way in which content is shared may be determined by the particular channel over which the content is shared. Different channels support different types of content. For example, Twitter supports 140-character text messages, which may include links. Thus, if the content item is posted to Twitter, the content that is posted may take the form of a text message, together with a link to the other parts of the content. If the content is posted on a site with richer content capabilities (e.g., Facebook, or the WINDOWS LIVE SPACES service), then additional portions of the content (e.g., images) may be posted. In general, the amount and type of content that is posted may be referred to as the “fidelity” of the content. Thus, a post containing just text and a link may be a low fidelity form of the content, while a post containing the original photo, the links, and the other elements of the full content experience that was created on device 102 may be considered a high fidelity form of the content. (Those “other elements” may include audio, video, temperature readings, GPS readings, or any other type of information.) One aspect of the subject matter herein is that the same underlying piece of content may be propagated at different fidelity levels. It is noted that the channel over which content is propagated is one limitation on what fidelity level will be used, since the channel may have limitations on what type/amount of content it will support. However, another limitation may be the device on which the content is to be viewed. For example, a Facebook post might be able to handle content at a relatively high fidelity level, but the content might be viewed on a device (e.g., a basic cell phone) that only supports low-fidelity viewing.

FIG. 2 shows an example scenario in which content may be authored and propagated. In the example of FIG. 2, an authoring and exploration application 202 runs on device 102. For example, application 202 may be a version of the MICROSOFT BING MOBILE application. Such an application may be installable on smart phones (or other types of devices), and may facilitate functions such as search, message authoring, message posting, or other functions.

Device 102 may receive various forms of input. For example, device 102 may receive a capture of image, audio, and/or sensor data 204. Data 204, in this context, includes any data that is captured with device's components. Audio data captured through a microphone, still image or video data captured through a camera, location data obtained from a GPS, and temperature data obtained through a thermometer are examples of data 204, although any other type of data could be obtained. This data 204 may be provided to device 102 and may be processed by application 202.

Device 102 may also receive user input 206. User input 206 may take the form of text input, such as input entered through a keypad, a mechanical keyboard, or an on-screen keyboard. Additionally user input 206 could be entered in other ways, such as through a text-to-speech component that converts audio captured through a microphone into text. User input 206 may also be provided to device 102, and may be processed by application 202. In general, user input 206 is data that the user enters in some explicit form (e.g., typing, handwriting recognition, etc.), while data 204 is data that is received in some way other than through explicit user input (e.g., sounds captured by microphone, images captured by camera, location data determined by a GPS, etc.). (It is noted that, even though a user may participate in the taking of a photo or recording a sound in the sense that the user instructs the device to capture an image or to start recording, the actual photo or sound that is captured is not input that is explicitly provided by the user.)

When application 202 receives image, audio and/or sensor data 204, and user input 206, application 202 may attempt to figure out how to react to that data. Application 202 may be configured to perform various functions, such as performing a search on the data and providing results, or helping the user to author a message about the data and input. In one example, application 202 is designed to combine these functions, by providing whatever information it can about the information it receives, and then helping a user to author a message using both the data and input that it receives, and also by using information received from other sources.

One example of an “other source” from which application 202 may receive information about data 204 and input 206 is a remote service 208. Device 102 may include a communication component (e.g., radio 116, shown in FIG. 1), which it may use to communicate with remote sources that are accessible via the Internet. For example, if device 102 is a cell phone, then the radio may allow the device to communicate with the Internet through cell towers and through the phone system. Remote service 208 is a service that may be accessible via such a network. Remote service 208 may perform general search and other lookup services. For example, remote service 208 may have the ability to react to a search query by providing search results, or may have the ability to react to still image data, video data, and/or audio data by matching the image, video, or audio against items in a database that remote service 208 maintains. As another example, remote service 208 may have geographic data that stores the locations of businesses and other entities, and may be able to identify what business a person is near based on a GPS location received from a device.

As a further example, remote service 208 may contain software that can suggest text messages and/or other forms of communication based on the data that it receives. For example, if image data and GPS data received from device 102 indicate that the person holding device 102 is standing in a book store, then remote service 208 might return information about the book store (e.g., a link to a particular book, a link to an online store operated by the same company as the physical store, a map of the location surrounding the store etc.), and may also return information that can be used to compose a message that relates to the fact that the user of the device is standing at a bookstore. Thus, remote service 208 might return data that could be used to construct the message “Robert is reading” based on the fact that the device is located at a book store. However, the same remote service 208 might return data that could be used to construct the message “Robert is watching a baseball game” if the data suggests that the user of the device is currently at a baseball stadium.

Thus, to summarize, remote service 208 returns results 210 in reaction to whatever data 204 and input 206 from device 102 is forwarded to remote service by application 202. Some example information that may be included in those results are:
links to relevant content;
images;
identifications of images that have been provided (e.g., if application 202 sends a photo of Space Needle, remote service 208 might return a link to the Space Needle web site);
audio;
an identification of audio that has been provided (e.g., if application 202 sends a recording of music, remote service 208 might return a link to purchase that song in an online music store);
suggested content for a text message (e.g., if application 202 sends an photo of Space Needle, then remote service 208 might return verb or other phrases that could be used in a message about a user's presence at Space Needle, such as “is visiting”, “likes the view”, etc.);
any other information that could be used to create a content experience on device 102.

When results 210 have been received on device 102, those results may be used to perform various actions. For example, a user may interact with the results. The various results may be shown to the user in the form of the interactive elements 120-126, which are shown in FIG. 1. Thus, if one of the results is a link to the Pacific Science Center (which is near Space Needle), then the user might be able to learn more about the Pacific Science Center by clicking on (or touching) the element that corresponds to the science center. Doing so might show the user the web site of the science center, a photo of the science center, a map of the area with the science center highlighted, etc., or any other type of content related to the science center. Or, if one of the results includes a “tweet” on Twitter concerning Space Needle, then the user could click on or touch the element corresponding to that result in order to read the post. Application 202 may assist the user in interacting with the results.

However, another type of action that application 202 may help the user to perform is authoring a media-rich message about the results, and/or about the information on which the results are based. Thus, the user might be able to choose portions of results 210 around which to build a message. If the user touches one of the elements 120-126 (shown in FIG. 1), this might indicate that the user wants to construct a message relating to what he is currently doing. Thus, the user would be shown an interface, such as that on the right-hand side of FIG. 1, which allows the user to build a message around (what application 202 has figured out is) the user's current trip to Space Needle. In general, the user may issue instructions to the device (e.g., in the form of touch screen gestures) that instruct the application to include various types of content in the message.

The message that the user builds may include various types of items. For example, as shown on the right-hand side of FIG. 1, the message may contain text, an image, audio, links, or any other type of content. The content may be data that was captured and/or entered at device 102. Or, the content may include results 210 that were received from remote service 208. In one example, the content to be included in the message is a combination of information received on a device and information received from a remote service. The user may be provided with an interactive interface that allows him to choose what content is to be included in the message. For example, by clicking on a certain type of content, a menu or dialog box could be provided that asks the user whether to include that content in the message, and what type of content (e.g., audio, video, images, text, links, etc.) are to be included. Or, the text message could be edited using menus. For example, if the message says “Robert likes Space Needle”, a menu of verb alternatives to “likes” (e.g., “dislikes,” “isn't sure about,” “wants to learn more about,” etc.) could be provided, thereby allowing the user to make changes to the text in the message.

Once the message is created, the message may be propagated through various channels 212. Some examples of these channels are: posting on a social networking site (e.g., Facebook); posting on a microblog (e.g., Twitter); sending an e-mail; storing the message in an online document service for future reference; etc. As noted above, the message may be propagated at different fidelities. Thus, on a microblog, the text portion of the message might be propagated along with a link to the richer content experience. On a social networking site, the message and still images might be propagated, along with a link to the richer content experience. When the message is propagated as an e-mail, then all of the content might be included in the e-mail (since e-mail can include many different types of content). However, in another example, the e-mail might contain a link to the full content experience, rather than containing all of the content itself.

In addition to propagating the message, the message in its highest fidelity may be stored in database 214. In the lower-fidelity forms of the message (e.g., text and a link), the link may point to the full content experience in database 214, thereby allowing recipients of the link to access the full content experience. It is noted that one aspect of the subject matter herein is a separation of (a) the fidelity at which content is propagated, from (b) the fidelity at which it is stored. Storing the content at its highest fidelity allows any lower-fidelity experience to be constructed, and subsequently propagated, from the original content. However, the ability to create lower-fidelity experiences of the same content allows the content to be propagated over a variety of channels, including those that cannot handle high fidelity content.

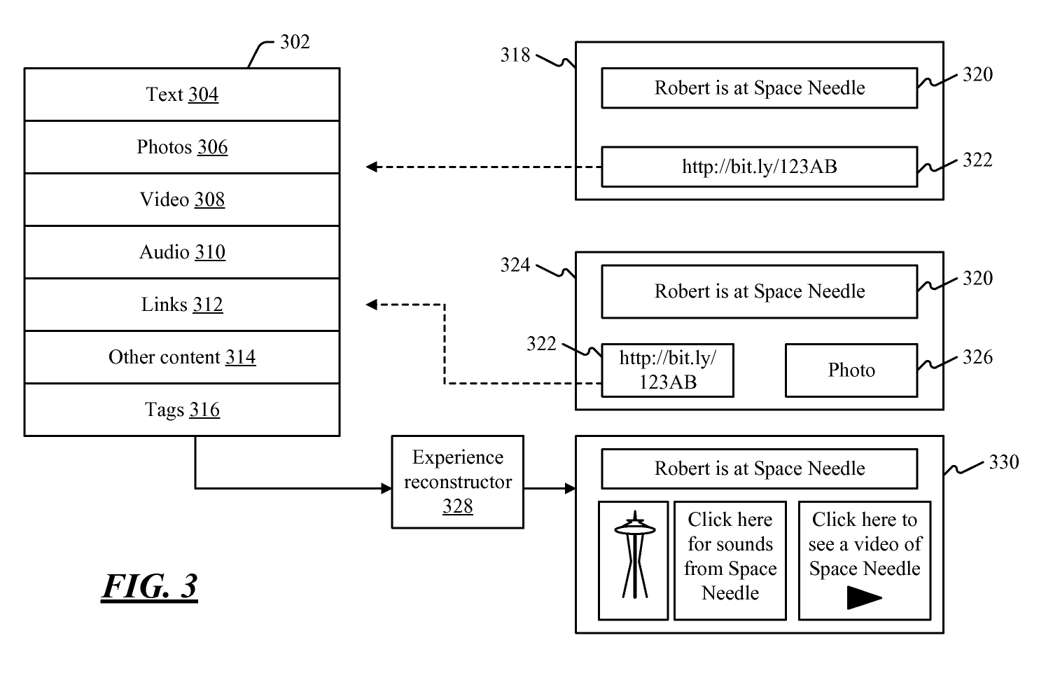

FIG. 3 shows an example scenario in which a given piece of content may be managed at various fidelities. An underlying piece of content 302 may be stored in a database (such as database 214, shown in FIG. 2). Content 302 may contain text 304, photos 306, video 308, audio 310, links, 312, or any other type of content 314. These various items of content may have been authored by the user with a mobile device application, in the manner described above. Content 302 may be stored in a structured form that maintains separation of the various different pieces and/or types of content. Thus, the form in which content 302 is stored may have a separate field for each piece of text, each photo, each video, and so on. Additionally, content 302 may be annotated through tags 316. For example, if one item in content 302 is a photo of Space Needle, tags 316 may identify that photo as being a photo of Space Needle. Additionally, tags 316 may indicate the time at which the photo was taken, the location (as recorded on a GPS device at the time the photo was taken), the air temperature at that time (as recorded by a thermometer), the name of the photographer, or any other type of information about the photo. Similar tags could be used to describe the text, the video, the links, or any other portion of the content. Tags might also provide sufficient information from which to reconstruct the original experience that led to the creation of the content. For example, if the user entered the search query “space needle”, and that query resulted in the photos, links, etc., that are included in content 302, then a tag containing that original search query could be included.

The information contained in tags 316 could be used for various purposes. For example, the information could be used anonymously by an analysis service in order to determine how people use their devices and what types of messages they choose to send. Or, the tags could be used to index content, so that the content can later be used in searches. (E.g., if a user takes a new photo of Space Needle, then the tag indicating that the photo is, in fact, a photo of Space Needle could be used to respond to future searches for that landmark.)

The structured form of content 302 may be the highest fidelity experience of that content—or, at least, it may contain sufficient information to reconstruct the highest-fidelity experience. However, the structured form of content 302 may be used to construct a content experience at various fidelities. FIG. 3 shows some examples of those fidelities.

In one example, content 302 is used to construct low-fidelity experience 318. Low-fidelity experience 318 contains text 320 and link 322. Low-fidelity experience 318 may be appropriate for posting on a microblog, such as Twitter, since microblogs are generally able to handle small amounts of text, including links. Link 322 points back to the underlying content 302, so that the high-fidelity experience can be reconstructed upon request. For example, a user might receive low-fidelity experience 318 in the form of a tweet on his smart phone, and then might click on link 322 to obtain the high-fidelity experience through a browser on that phone.

In another example, content 302 is used to construct medium-fidelity experience 324. Medium-fidelity experience 324 contains text 320, link 322, and photo 326. Medium-fidelity experience may be appropriate for posting on a social networking site, such as Facebook. As with low-fidelity experience 318, the link 322 in medium-fidelity experience points back to the underlying content 302, from which the high-fidelity experience can be constructed. Thus, a user might receive medium-fidelity experience in the form of a social network post, and might click on link 322 in order to view the high-fidelity experience.

The high-fidelity experience of content 302 can be reconstructed from the underlying content by an experience reconstructor 328. Experience reconstructor 328 may take the form of software that reads the underlying structured form of content, and constructs a user-friendly experience of that content. Experience reconstructor 328 may be able to construct a content experience at several fidelity levels, and thus it may be used to construct low-fidelity experience 318 and medium-fidelity experience 324, as well as high-fidelity experience 330. When reconstructor 328 is used to construct high-fidelity experience 330, then that experience may appear as is shown in FIG. 3. For example, high-fidelity experience 330 may contain text content, a photo, a video player that plays a video taken at Space Needle, an audio player that plays sounds recorded at Space Needle, or any other type of content. Thus, high-fidelity experience 330 may be what a user experiences if the user clicks the link 322 contained in low-fidelity experience 318 or in medium-fidelity experience 324.

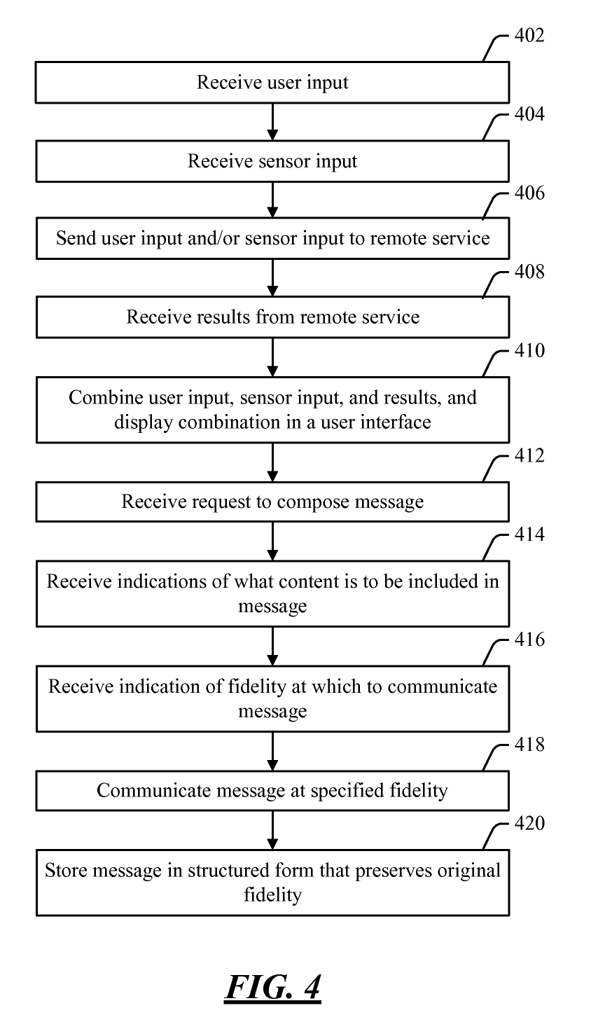

FIG. 4 shows an example process in which content may be authored. Before turning to a description of FIG. 4, it is noted that the flow diagram contained in FIG. 4 is described, by way of example, with reference to components shown in FIGS. 1-3, although this process may be carried out in any system and is not limited to the scenarios shown in FIGS. 1-3. Additionally, the flow diagram in FIG. 4 shows an example in which stages of a process are carried out in a particular order, as indicated by the lines connecting the blocks, but the various stages shown in FIG. 4 can be performed in any order, or in any combination or sub-combination.

At 402, user input is received. The user input may be received, for example, in the form of text that a user enters through a keypad, a mechanical keyboard, or an on screen keyboard. At 404, sensor input is received. Sensor input may be any type of input that is received through components of a device, such as still image or video input received through a camera, audio input received through a microphone, location data received through a GPS device, temperature data received through a thermometer, or any other type of input.

At 406, the user input and/or the sensor input may be sent to a remote service. For example, an application that runs on a user's device may assist the user by contacting a remote search engine (or other type of service) to obtain information about the input that has been entered and/or captured on the device. The user input and/or sensor input may be provided to such a remote service. At 408, results are received from the remote service. The results may take any form—e.g., links to relevant web sites, images, video, audio, maps. Or, the results may contain identifications of images, video, audio, locations, etc., that were provided to the remote service. Or, as a further example, the results may contain suggested content (e.g., suggested text) to be included in a message.

At 410, the user input, the sensor input, and/or the results may be combined, and this combination may be displayed in a user interface. For example, the left-hand-side drawing of device 102 in FIG. 1 shows a photo of Space Needle (an example of sensor input) and elements that refer to objects located near Space Needle (which were obtained as part of results from a remote service). Thus, the left-hand-side drawing in FIG. 1 shows an example of a user interface that combines input and results.

At 412, a request to compose a message may be received. For example, a user may click on, or touch, some element of a user interface shown on the user's device, thereby indicating that the user wants to compose a message based on the content. At 414, the user indicates (through appropriate input mechanisms, such as a touch screen) what content is to be included in the message. For example, the user may choose to include text (which may involve modifying some text that an application has proposed), photos, links, audio, etc. In one example, the content that is created comprises at least one non-text, non-link item. E.g., such an item might contain text, a link, and a video, or might contain text and an audio clip. In the first of these examples, the video is a non-text, non-link item; in the second of these examples, the audio clip is a non-text, non-link item.

At 416, an indication is received of a fidelity at which to communicate the message that has been composed. As described above, the same underlying content may be shown in various fidelities (such as low-, medium-, and high-fidelity). A particular fidelity may be chosen based on the channel over which the user wants to transmit the message. E.g., requesting to post the message on Twitter might result in the message being communicated at low fidelity, while requesting to post the message on Facebook might result in the message being communicated at medium fidelity. Once the particular fidelity is selected, the message is communicated at that fidelity, at 418.

Although the message may be communicated at a particular fidelity, the high-fidelity version of the message may be stored at 420. This high-fidelity version of the message may take the form of structured data from which a high-fidelity content experience can be reconstructed, as discussed above in connection with FIG. 3.

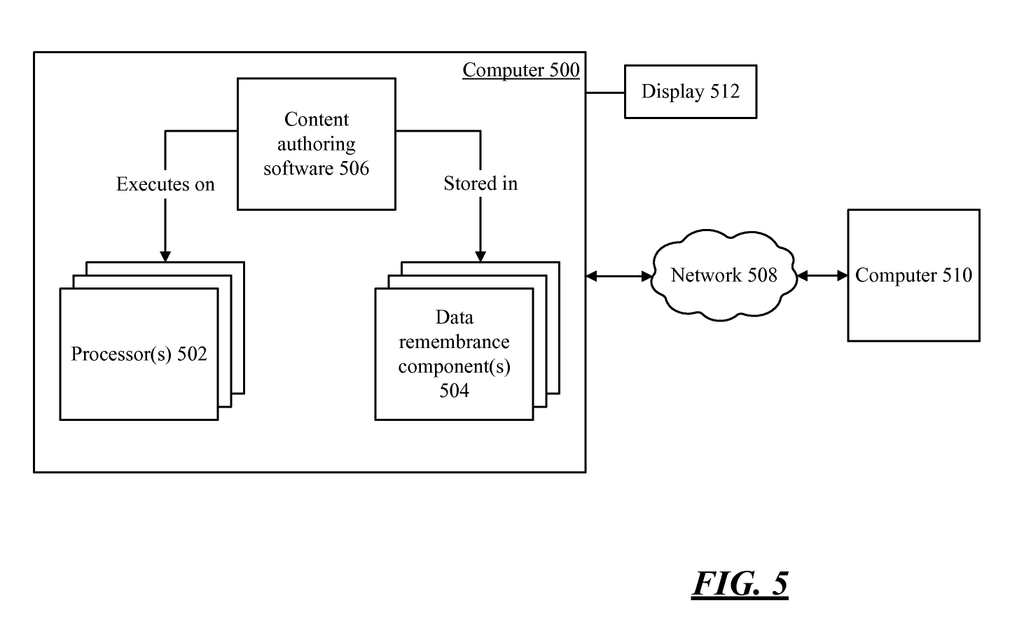

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is content authoring software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable (or device-readable) storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable (or device-readable) storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more device-readable storage media that store executable instructions to create and propagate content, wherein said executable instructions, when executed by a device, cause the device to perform acts comprising:
receiving input from a user through an input mechanism of said device;
receiving data from a component of said device, said data being other than user input;
sending, through a network, said input and said data to a service that is remote from said device;
receiving, from said service, a result;
receiving, from said user, one or more instructions to author said content on said device using information that comprises said result, wherein said content comprises at least one non-text, non-link item;
selecting a fidelity at which to propagate said content; and
propagating said content through a channel at said fidelity.

2. The one or more device-readable storage media of claim 1, wherein said result comprises a video, and wherein said non-text, non-link item comprises said video or a video player that plays said video.

3. The one or more device-readable storage media of claim 1, wherein said result comprises blog or microblog post, and wherein said content comprises said post or a link to said post.

4. The one or more device-readable storage media of claim 1, wherein said content comprises text and an image, video, or audio, and wherein said propagating of said content comprises:
posting said content at a low fidelity that includes said text and a link to a high fidelity version of said content, wherein said low fidelity does not include said image, video, or audio.

5. The one or more device-readable storage media of claim 1, wherein said content comprises text and an image, and also comprises video or audio, and wherein said propagating of said content comprises:
posting said content at a fidelity that includes said text, said image, and a link to a full version of said content, wherein said fidelity does not include said video or said audio.

6. The one or more device-readable storage media of claim 1, wherein said acts further comprise:
storing said content in a structured form from which a plurality of fidelities of said content can be reconstructed.

7. A method of creating and propagating content, the method comprising:
using a processor to perform acts comprising:
receiving input from a user through an input mechanism of a device, or data, other than user input, from a component of said device;
sending said input or said data to a service that is remote from said device;
receiving, from said service, a result;
receiving, from said user, one or more instructions to author said content on said device using said input or said data, and also using said result; and
propagating said content through a channel at a fidelity that is supported by said channel.

8. The method of claim 7, wherein said result comprises a video, and wherein said content comprises said video or a video player that plays said video.

9. The method of claim 7, wherein said result comprises audio, and wherein said content comprises said audio or an audio player that plays said audio.

10. The method of claim 7, wherein said result comprises a link to a web site, wherein said instructions instruct an application that performs said method to include said link, and wherein said content comprises said link.

11. The method of claim 7, wherein said content comprises text and further comprises an image, video, or audio, wherein said propagating of said content comprises:
posting said content at a low fidelity that includes said text and a link to a high fidelity version of said content, wherein said low fidelity does not include said image, video, or audio.

12. The method of claim 7, wherein said content comprises text and an image, and further comprises a video or audio, wherein said propagating of said content comprises:
posting said content at a fidelity that includes said text, said image, and a link to a full version of said content, wherein said fidelity does not include said video or said audio.

13. The method of claim 7, wherein said acts further comprise:
storing said content;
receiving a request for said content at a particular fidelity;
providing said content at said fidelity.

14. A device for communicating content, wherein the device comprises:
a memory;
a processor;
an input mechanism that receives input from a user of said device;
a first component that creates data by sensing or capturing information; and
a second component that sends, through a network, said input and said data to a service that is remote from said device, that receives, from said service, a result, that receives, from said user, an instruction to author said content using information that comprises said result, wherein said content comprises at least one non-text, non-link item, wherein said second component receives an indication of a channel through which to propagate said content, and wherein said second component propagates said content through said channel at a fidelity that is supported by said channel.

15. The device of claim 14, wherein said result comprises a video, and wherein said content comprises said video or a video player that plays said video.

16. The device of claim 14, wherein said result comprises blog or microblog post, and wherein said content comprises said post or a link to said post.

17. The device of claim 14, wherein said result comprises a link to a web site, and wherein said content comprises said link.

18. The device of claim 14, wherein said content comprises text and further comprises an image, video, or audio, wherein said second component propagates said content at a low fidelity that includes said text and a link to a high fidelity version of said content, and wherein said low fidelity does not include said image, video, or audio.

19. The device of claim 14, wherein said content comprises text and an image, and further comprises a video or audio, wherein said second component propagates said content at a fidelity that includes said text, said image, and a link to a full version of said content, and wherein said fidelity does not include said video or said audio.

20. The device of claim 14, wherein said device stores said content in a structured form from which a plurality of fidelities of said content can be reconstructed.
